(19) United States
(12) Patent Application Publication
(10) Pub. No.: US 2025/0284997 A1
(43) Pub. Date: Sep. 11, 2025

(54) LEARNING TO SIMULATE QUANTUM SYSTEMS: DYNAMICAL CIRCUIT CUTTING

(71) Applicant: HEWLETT PACKARD ENTERPRISE DEVELOPMENT LP, Spring, TX (US)

(72) Inventors: Katherine Grace Johnson, San Francisco, CA (US); Masoud Mohseni, Calabasas, CA (US); Xin Zhan, Sugar Land, TX (US)

(21) Appl. No.: 18/787,587

(22) Filed: Jul. 29, 2024

Related U.S. Application Data
(60) Provisional application No. 63/562,457, filed on Mar. 7, 2024.

(51) Int. Cl. G06N 10/60; G06N 10/40; G06N 20/00

(52) U.S. Cl. CPC G06N 10/60; G06N 10/40; G06N 20/00

(57) ABSTRACT

A method of simulating a quantum system that efficiently partitions quantum circuits to enable high-performance quantum computing utilizing multiple QPUs in parallel. The method comprises using a tensor network ansatz to represent the quantum system, partitioning and optimizing quantum circuits based on the TN ansatz, then using machine learning to optimize the TN parameters to minimize entanglement between partitions. The method operates in a hybrid quantum-classical environment, where information is shared between QPUs with existing HPC infrastructures.

### CROSS REFERENCE TO RELATED APPLICATION

This application claims priority to U.S. Provisional Application No. 63/562,457, filed Mar. 7, 2024, which is incorporated by reference herein in its entirety.

### INTRODUCTION

Quantum computing utilizes quantum states to represent information and processes that information by manipulating those quantum states. A basic unit of information in quantum computing is a quantum bit, also called a qubit. The qubit may be analogous to the bit in classical computing, except that with qubits the information is encoded as quantum states (e.g., the spin of an electron) and each qubit can have more than two states and may also be affected by various quantum effects which may not affect classical bits, such as quantum entanglement, quantum decoherence, etc. The term qubit can be used to refer both to the unit of information and to the underlying physical thing which represents or embodies that unit of information.

A quantum computer may comprise a quantum processor. A quantum processor comprises a collection of qubits (or hardware which can create the cubits when needed) together with hardware configured to initialize and manipulate the qubits. The qubits may be physically interacted with (e.g., via excitation by a laser, as one example) to cause them to change their quantum states. In this manner, the information represented by the qubits can be manipulated and processed.

Quantum processors can also be simulated using classical hardware. In contrast to a physical quantum processor which embodies the qubits in physical form (e.g., electrons of ions trapped in a crystal shell) and which changes the quantum states of the qubits by physically interacting with them, a simulated quantum processor may numerically model the qubits and change their states by applying mathematical transformations thereto based on quantum mechanical principles.

Some quantum processors, including both physical and simulated quantum processors, may manipulate the information encoded in their qubits through the application of quantum logic gates (quantum gates). A quantum logic gate is analogous to a classical logic gate, except that the quantum gate operates on quantum bits according to quantum mechanical principles. The application of a quantum gate to a qubit in a physical quantum processor may involve physically interacting with the qubit, whereas the application of a quantum gate in a simulated quantum processor may involve the mathematical manipulation of the numerical values which simulate the qubit. Multiple quantum gates may be applied in series and/or in parallel, with the collection of quantum gates forming a so-called quantum circuit. Quantum circuits may be designed to manipulate the qubits in a way which produces a desired outcome, such as to model the real time evolution of a quantum system of interest.

For example, to model the real time evolution of a quantum system, the quantum processor may prepare the qubits to an initial state representative of the quantum system being modeled by the application of a quantum circuit which represents the initial quantum state and then apply additional quantum circuits which are expected to manipulate the qubits in a manner which mimics the real time evolution of the quantum system being simulated. To simulate the evolution exactly may require knowledge of the Hamiltonian of the quantum system, which is a matrix operator related to the energy of the system. If the Hamiltonian is known, the evolution of the quantum system over time t can be mathematically modeled with the equation |ψ(t) [symbol] =e^{-iHt}|ψ(0) [symbol] , where H is the Hamiltonian, |ψ(0) [symbol] is the initial state of the system, and |ψ(t) [symbol] is the state of the system at time t.

However, the Hamiltonian is often not known, and even when known may be difficult to model exactly. Thus, to allow for the approximate simulation of the evolution of the quantum system, the evolution may be discretized into time steps using the so-called Trotter method. The method works best when the Hamiltonian can be written as a sum of local terms Hⱼ, i.e. terms which affect only neighboring qubits. Using this approach, the evolved state of the system at time t may be approximated as:

$$\vert ψ ( t ) 〉 \approx {( {\prod }_{j} {e}^{- i {a}_{j} {H}_{j} t / r} )}^{r} \vert ψ ( 0 ) 〉$$

where r is the number of timesteps, Hⱼ are local terms in the Hamiltonian, and aⱼ are coefficients or weights for each local term. In this approach, at each time step, a particular quantum circuit corresponding to that timestep is applied to the qubits, such that when all of the Trotter timesteps have been performed, the end state of the system approximates |ψ(t) [symbol] (with large enough r, the result converges on |ψ(t) [symbol] ).

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 comprises a block diagram illustrating an example hybrid quantum-classical computing system.

FIGS. 2A and 2B comprise schematic diagrams illustrating aspects of a dynamical circuit cutting process such as may be performed by the hybrid quantum-classical computing system of FIG. 1. FIG. 2A shows partitioning of quantum circuits.

FIG. 2B shows application of the quantum circuits to qubits during Trotter timesteps.

FIG. 3 comprises a schematic diagram illustrating aspects of one example implementation of the dynamical circuit cutting process of FIGS. 2A and 2B.

FIG. 4 comprises a schematic diagram illustrating aspects of one example implementation of the dynamical circuit cutting process of FIG. 3 showing a first Trotter timestep.

FIG. 5 comprises a schematic diagram illustrating aspects of the dynamical circuit cutting process of FIG. 4 showing a second Trotter timestep.

FIG. 6 comprises a process flow chart illustrating an example method of simulating a quantum system.

FIG. 7 comprises a process flow chart illustrating another example method of simulating a quantum system.

### DETAILED DESCRIPTION

Quantum computing is expected to, when it has matured, bring about great advances in computing power, and to eventually exceed the possibilities of classical computing for certain important tasks. However, so far it has proven difficult to produce working quantum processors which realize this full potential. One reason for this is that it is relatively difficult to produce stable quantum systems with large numbers of qubits. To date, the largest quantum processors have on the order of 100 qubits, and commonly have less than this in practical examples. These quantum processors may also be relatively noisy, due to issues with quantum decoherence or other quantum effects. Accordingly, the current era of quantum computing is sometimes referred to as the noisy intermediate-scale quantum (NISQ) era, and currently available quantum processors may be referred to as NISQ processors.

It is estimated that on the order of a few million to tens of millions of qubits may be needed in order to achieve the desired performance for some applications, such as modeling quantum systems for quantum dynamics research or quantum chemistry research, or integer factoring. Thus, currently available NISQ processors are not yet capable, on their own, of achieving the desired levels of performance.

Furthermore, simulated quantum processors also are limited in the number of qubits they can represent. The storage space needed for the simulation grows exponentially with the addition of each qubit, and thus very powerful classical computers may be needed to simulate even rather modest quantum computers. For example, simulated quantum processors having 40 qubits have been demonstrated using a classical computer with 128 nodes and 512 graphics processing units (GPUs).

In view of the current unavailability of quantum processors (whether physical or simulated) having large numbers of qubits, one way to approach quantum computing tasks that involve many qubits is to divide that task up between multiple separate quantum processing units (QPUs) which each have a small number of qubits. With such an approach, the full quantum circuit which would have been applied to all the qubits if a sufficiently large QPU were available would instead be partitioned (i.e., cut) into many smaller quantum circuits which are applied by the smaller QPUs to subsets of the qubits.

Tensor network (TN) approaches may be used to partition the quantum circuit in this manner. A TN approach decomposes the tensor which represents the quantum state |ψ [symbol] into a network of multiple smaller tensors which are computationally easier to handle. These tensors may be characterized by a bond dimension χ. If the bond dimension is large enough, the decomposed tensors may represent the quantum state |ψ [symbol] exactly, but in practice a smaller bond dimension may be used to compress the tensor and simplify computations at the cost of introducing some error. The decomposed tensor network may then be converted into corresponding quantum circuits that represent the quantum state by known techniques. Examples of known TN approaches include Matrix Product State (MPS), Projected Entangled Pair States (PEPS), and Tree Tensor Networks (TTN).

When such TN approaches are used to partition the quantum circuit across multiple QPUs, some quantum correlation information may be lost, and therefore subsequent to the quantum processing, classical computers may be employed to combine the results and retrieve some of this lost information. This can be viewed as knitting the previously partitioned quantum circuits back together. These approaches rely on a combination of quantum and classical compute power, and thus may also be characterized as hybrid quantum-classical compute approaches.

The TN-circuit cutting approaches described above may be combined with the Trotter discretization approach mentioned above. In such a case, the partitioned quantum circuits determined according to the TN-circuit cutting approaches are applied by the multiple QPUs at each Trotter timestep. The classical processing which is performed to recover lost information and “knit” the circuits back together may be performed after each Trotter timestep has been completed.

While the combination of time discretization via the Trotter method and partitioning of the quantum circuit via TN-circuit cutting approaches can be effective for some use cases, such as one-dimensional quantum systems, they tend to not scale very well to other systems. In particular, due to the partitioning of the TN-circuit cutting approaches, certain quantum correlations between qubits may be lost, and to recover this information may require extensive classical computations after the QPUs have completed their quantum processing. The classical computation can become very large, growing exponentially with the number of qubits, and thus great amounts of classical compute power may be needed when trying to simulate quantum systems with even modest numbers of qubits, and may be infeasible when large numbers of qubits are involved. In addition, it's not straightforward how to best partition the quantum circuit for many applications. While certain simpler applications, such as one-dimensional systems, have been studied for TN-circuit cutting approaches, partitions for more complex systems may be unknown.

To address these and other issues, disclosed herein is a high-performance quantum-classical computing approach that uses dynamical circuit cutting, which comprises using machine learning to dynamically learn how to efficiently simulate a quantum mechanical system during the simulation thereof. More specifically, the high-performance quantum-classical computing approach may utilize multiple QPUs (physical QPUs or simulated QPUs), which work together to simulate a quantum system using a TN-circuit-cutting approach with Trotter time discretization as described above, but unlike previous approaches the systems described herein may use machine learning during one or more of the Trotter timesteps (in some cases, each timestep) to dynamically optimize parameters of the simulation, which may then be used by the system during subsequent Trotter timesteps. In this manner, the system dynamically learns how to optimally perform the simulation while doing the simulation.

In some examples, the QPUs may be deployed as co-processors in a larger classical computing system, such as a High-Performance-Compute (HPC) system. The classical computing system performs the machine learning which optimizes the simulation, while the QPUs carry out the simulation. In this sense, the approach disclosed herein may be characterized as a hybrid quantum-classical approach or algorithm. The optimization performed by the classical computing may also be considered, in some aspects, as a means of message passing between the QPUs. This optimization may enable many of the QPUs to be combined together, thus allowing for the system to be scaled up to relatively large sizes. For example, using currently available NISC QPUs (physical or simulated), the overall system could feasibly be scaled up to thousands of qubits. Moreover, the approach is hardware agnostic, meaning it can work with any form of physical QPU or any simulated QPU or any combination of these.

In some examples, the parameters which are optimized during one or more of the timesteps include parameters which characterize the TN partitioning of the quantum circuit (i.e., the TN ansatz), such as the set of bond dimensions {χ^{t}} and a set of parameters {γ} which characterize the TN layout. In other words, rather than having a static predetermined partitioning (i.e., a static TN ansatz) that is used throughout all Trotter timesteps, the partitioning may change between timesteps as the parameters thereof are optimized. Optimizing the partitioning may be thought of as determining which quantum correlations to keep and which to ignore, and by dynamically learning which such correlations to keep or ignore, the impact of recovering correlations can be minimized. Specifically, the TN partitioning parameters may be optimized so as to minimize entanglement. Entanglement refers to dependencies or correlations between qubits, i.e., if a group of qubits are entangled then the state of one qubit is correlated with, and cannot be fully described independently of, the state(s) the other qubit(s). If entangled qubits are separated during the partitioning, then some of the quantum correlation information between these qubits is lost and needs to be recovered later on, with the recovery being done by classical processing. More quantum correlation information may be lost if the cutting occurs where there is a high degree of entanglement, and thus by optimizing the partition parameters to perform cutting at points that minimize the degree of entanglement, the amount of quantum correlation information that is lost due to the partitioning may be decreased. Because the amount of quantum correlation information that is lost is decreased, the degree to which classical processing is needed to recover such information may be decreased, allowing for more complex problems to be tackled without overwhelming the available classical compute. Put another way, the machine learning may be trained to indicate locations of optimal cutting (e.g., an entanglement heatmap can be learned and boundaries can be found where cuts can be made with least consequence) to minimize the amount of quantum information required to pass between subsystems.

Turning now to the Figures, examples of the above-described dynamical circuit cutting approach and systems configured to carry it out will be described in greater detail.

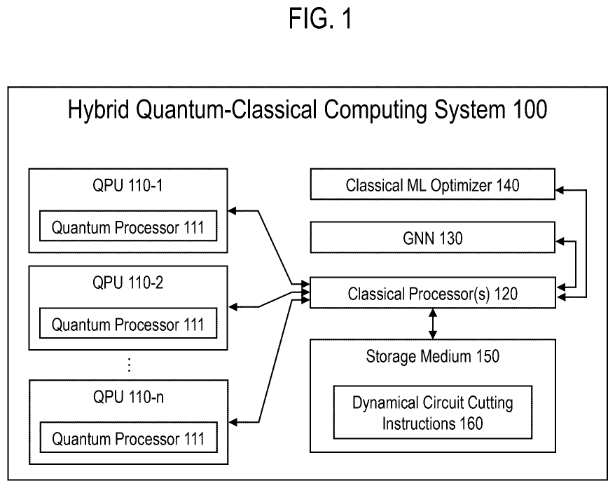

FIG. 1 illustrates a hybrid quantum-classical computing system 100 configured to perform dynamical circuit cutting. The system 100 comprises a plurality of quantum processing units (QPUs) 110, one or more classical processor(s) 120, a graph neural network (GNN) 130, a classical machine learning (ML) optimizer 140, and a non-transitory data storage medium 150 storing dynamical circuit cutting instructions 160. These components will be described in turn below.

The QPUs 110 may include QPU 110-1 to QPU 110-N as illustrated in FIG. 1, with N being any integer equal to or greater than 2. These QPUs 110 may be physical or simulated QPUs, or a mix thereof. In some examples, the system 100 may be a High-Performance-Compute (HPC) system which comprises a plurality of compute nodes which work together to form a unified system, with the QPUs 110 being deployed as co-processors in the system 100. Each QPU 110 comprises a quantum processor 111 (physical or simulated) which comprises a plurality of qubits (physical or simulated). Each QPU 110 may be configured to apply quantum circuits to the qubits thereof, thereby modeling or simulating quantum states of a quantum system and/or evolution of such a system over time.

The classical processor(s) 120 comprise one or more processors, which may be any form of device configured to process information. These processors 120 may be general purpose processors or application-specific processors. For example, the processors 120 may include systems-on-chip (SOC), central processing units (CPUs) (e.g., x86, ARM, or other), graphical processing units (GPUs), application specific integrated circuits (ASICs), or any other processor. The classical processor(s) 120 are configured to communicate with the other components of the system 100 and to control operations of the system 100.

In particular, the classical processor(s) 120 read the dynamical circuit cutting instructions 160 from the storage medium 150 and execute these instructions to cause the system 100 to perform the dynamical circuit cutting approaches described herein. The dynamical circuit cutting instructions 160 cause the processors 120 to simulate a quantum system on the QPUs 110 using a TN-circuit-cutting approach with Trotter time discretization, while using machine learning during one or more of the Trotter timesteps (in some cases, each timestep) to dynamically optimize various parameters of the simulation, which may then be used by the system during subsequent Trotter timesteps. In this manner, the processor(s) 120 dynamically learn the optimal manner in which to simulate the quantum system while actively simulating the quantum system—i.e., the simulation improves and becomes more optimal as it is carried out. This dynamical circuit cutting will be described in greater detail below.

As noted above, in some examples, the QPUs 110 may be simulated QPUs, in which case they may be instantiated on classical processors executing instructions to run simulations of quantum processors. In some of these examples, the classical processors which simulate the QPUs 110 may be in addition to the classical processors 120 (i.e., some processors simulate the QPUs 110 while other processors perform/control the dynamic circuit cutting). In other examples, the classical processors which simulate the QPUs 110 may be one-and-the-same as the classical processors 120 (i.e., the classical processors 120 are performing multiple roles simultaneously, including a role of simulating a QPU and a roll of performing/controlling the dynamic circuit cutting process).

As noted above, the processor(s) 120 may use machine learning to optimize various parameters of the quantum simulation being carried out on the QPUs 110 while the simulation is ongoing. The GNN 130 and classical ML optimizer 140 and may perform this optimization, under the direction/control of the classical processors 120.

The GNN 130 may be configured to optimize TN parameters which characterize the TN partitioning of the overall quantum circuit (i.e., the TN ansatz) applied to the QPUs 110. These TN parameters which are optimized may include a set of bond dimensions {χ^{t}} and a set of parameters {γ} which characterize the TN layout. The GNN 130 may include any available GNN, such as a GNN embodied by classical hardware. The GNN 130 may be configured to minimize a difference between the parameterized TN and a reference signal. The reference signal may be provided by a full state-vector simulation, a physical experiment, and/or a set of target states/unitaries/local observables' outcomes. In some examples, the optimization of the TN parameters is performed in multiple Trotter timesteps (e.g., in all timesteps, in some examples). Thus, rather than having a static predetermined partitioning (i.e., a static TN ansatz) that is used throughout all Trotter timesteps, the partitioning may change between timesteps as the parameters thereof are optimized.

Optimizing the partitioning may be thought of as determining which quantum correlations to keep and which to ignore, and by dynamically learning which such correlations to keep or ignore, the impact of recovering correlations can be minimized. Specifically, the TN partitioning parameters may be optimized so as to minimize entanglement. In other words, the optimizing may comprise finding boundaries of minimal entanglement in the quantum system. Thus, the amount of quantum correlation information that is lost due to the partitioning may be decreased, and therefore the degree to which classical processing is needed to recover such information may be decreased, allowing for more complex problems to be tackled without overwhelming the available classical compute. Put another way, the GNN 130 may be trained to indicate locations of optimal cutting (e.g., an entanglement heatmap can be learned and boundaries can be found where cuts can be made with least consequence) to minimize the amount of quantum information required to pass between subsystems. The finding of the boundaries of minimal entanglement during the optimization of the TN parameters can be done with various approaches, including entanglement witnesses, von Neumann entropy, measuring non-local quantum observables, quantum tomography, bipartite entanglement entropy, etc. These are all measurements or properties of the quantum state which can characterize the entanglement pattern among the qubits. In some examples, information from one of these approaches could be used directly to inform where to cut. In other examples, to obtain a more accurate or optimal result the information obtained from these approaches could be used to construct (e.g., train) the GNN 130 using measurements/properties from one or multiple of these various approaches.

The classical ML optimizer 140 may be configured to optimize parameters which characterize or parameterize the individual quantum circuits being applied by the individual QPUs 110. For example, in some implementations, the quantum circuit applied by each QPU 110 may be parameterized by a vector θ, and these parameters θ may be optimized. Specifically, a first QPU 110-1 may apply a quantum circuit U₁(θ₁) parameterized by parameter θ₁, a second QPU-2 applies circuit U₂(θ₂), and so on up to QPU-n which applies circuit Uₙ(θₙ), and each of the parameters θ₁, . . . , θₙ may be optimized. The classical ML optimizer 140 may comprise one or more classical processors or special-purpose hardware applying any known machine learning optimization approaches to optimize for the parameters θ₁, . . . , θₙ. For example, the classical ML optimizer 140 may comprise any of the many off-the-shelf (commercially available) ML optimizers which have been further configured to optimize for the parameters θ₁, . . . , θₙ. In some examples, the classical processor(s) which form the classical ML optimizer 140 may be in addition to the classical processors 120 (i.e., some processors instantiate the ML optimizer 140 while other processors perform/control other aspects of the dynamic circuit cutting). In other examples, the classical processors which form the classical ML optimizer 140 may be one-and-the-same as the classical processors 120 (i.e., the classical processors 120 are performing multiple rolls simultaneously). In some examples, the classical ML optimizer 140 may be configured to optimize for θ based on the objective/cost functions:

$$max ℱ = {\sum }_{p} {\vert 〈 {ψ}_{Q C p}^{M} ( t ) \vert {ψ}_{MPSp} ( t ) 〉 \vert}^{2} \\ or \\ min ‖ \cdot ‖ = {\sum }_{p} \vert 〈 {ψ}_{QCp}^{M} ( t ) \vert {𝒪}_{p} \vert {ψ}_{QCp}^{M} ( t ) 〉 - 〈 {ψ}_{MPSp} ( t ) \vert {𝒪}_{p} \vert {ψ}_{MPSp} ( t ) 〉 \vert$$

In some examples, optimization of the quantum circuit parameters θ is performed in multiple Trotter timesteps (e.g., in all timesteps, in some examples), as will be described in greater detail below.

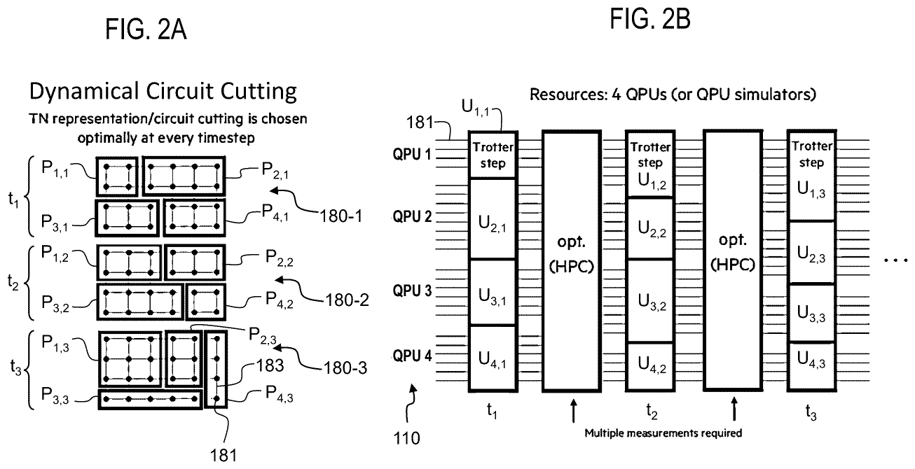

The storage medium 150 comprises one or more non-transitory data storage devices, such as solid-state drives (SSDs), hard disk drives (HDD), random-access-memory (RAM), or any other storage devices which are readable by the processor(s) 120. The dynamic circuit cutting instructions 160 stored in the storage medium 150 comprise processor-executable instructions which are executable by the processor(s) 120 to cause the processors 120 to perform operations described herein for dynamic circuit cutting, including any of the operations described below in relation to FIGS. 2A-7.

The dynamic circuit cutting process which may be performed by the system 100 will now be described in greater detail with reference to FIGS. 2A-7. In the example of FIGS. 2A-5, the system 100 has four QPUs 110, which are labeled as QPU1, QPU2, QPU3 and QPU4 in FIGS. 2A-5, but this number is merely used for illustrative purposes and it should be understood that the same principles apply to the system 100 having any number of QPUs 110.

FIGS. 2A and 2B are schematic diagrams illustrating an overview of one example high-performance quantum-classical computing approach disclosed herein using dynamical circuit cutting. FIGS. 2A and 2B illustrate four QPUs (which may be physical QPUs, simulated QPUs, or a combination of both) which are simulating a quantum system, with three time periods t1, t3, and t3 being shown as examples. The simulation uses a TN-circuit cutting approach with Trotter time discretization, as described above, and time periods t1, t2, and t3 are Trotter timesteps thereof in which Trotter gates may be applied. An initial time period t0 may also occur, which may be different from the other timesteps, but this is not illustrated in FIG. 2A or 2B. More or fewer QPUs may be used and more or fewer Trotter timesteps could occur in practice. FIG. 2A shows schematically how the overall quantum circuit 180 (i.e., TN ansatz180) may be partitioned during each time period, with rectangles indicating partitions P, dots indicating qubits 181 operated on by the circuit 180, and lines connecting dots indicating qubit connectivity 183, i.e. available two-qubit gates in the circuit. The partition P_{1,1} corresponds to the partition assigned to QPU 1 in the first timestep t1, the partition P_{2,1} corresponds to the partition assigned to QPU 2 in the timestep t1, and so on (i.e., the notation P_{i,j} indicates the partition assigned to the ith QPU in the jth timestep). Because there are four QPUs 110 in the illustrated example, there are four partitions P in each timestep, one for each of the QPUs 110. If more or fewer QPUs 110 were used, then corresponding numbers of partitions P may be found in each timestep.

As shown, the partitions P, and hence the ansatz 180, may dynamically change from one timestep to another. Specifically, in timestep t1 the TN ansatz 180 has the form of ansatz 180-1 with partitions P_{1,1} to P_{4,1}, in timestep t1 the TN ansatz 180 has the form of ansatz 180-2 with partitions P_{1,2} to P_{4,2}, in timestep t2 the TN ansatz 180 has the form of ansatz 180-3 with partitions P_{1,3} to P_{4,3}, and so on with each timestep.

FIG. 2B shows the quantum circuits U being applied to qubits during each Trotter timestep. The applications of these circuits and Trotter gates may be referred to as Trotter steps. In FIG. 2B the qubits are depicted as horizontal lines, and the quantum circuits U are depicted as rectangles. The rectangle U_{1,1} represents the circuit applied by QPU 1 in timestep t1 (which is based on the partition P_{1,1}), the rectangle U_{2,1} represents the circuit applied by QPU 2 in timestep t1 (which is based on the partition P_{2,1}), and so on (i.e., the notation U_{i,j} indicates the circuit applied by the i^{th} QPU in the j^{th} timestep). Note how the qubits 181 which are processed by each QPU 110 may change from one timestep to another as the TN partition dynamically updates. For example, in time period t1 the QPU1 is shown in FIG. 2B applying quantum circuit U_{1,1} to four qubits 181, which correspond to the four cubits of the t1 partition P_{1,1} in FIG. 2A, but in time period t2 the QPU1 is shown in FIG. 2B applying quantum circuit U_{1,2} to six qubits 181, which correspond to the six cubits of the t2 partition P_{1,2} in FIG. 2A. The quantum circuits U represent the quantum state of the simulated quantum system. Although not shown in this figure, each Trotter step may also include the application of Trotter gates which cause/simulate the evolution of the quantum state.

As shown in FIG. 2B, optimization processes (denoted “opt. (HPC)” in FIG. 2B) are performed during each Trotter timestep between the applications of the partitioned quantum circuits of a given Trotter step. These optimizations may be performed through machine learning using classical compute (denoted HPC in FIG. 2B, as one example). Specifically, in some examples the GNN 130 and/or the classical ML optimizer 140 are used to perform the optimizations, as will be described in greater detail below. These optimizations are what are used to update the partitions from one timestep to the next.

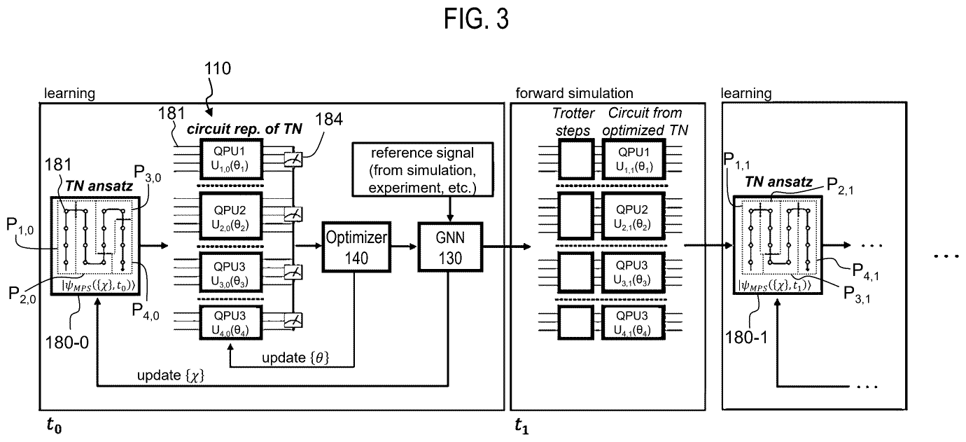

FIG. 3 illustrates one example implementation of the example high-performance quantum-classical computing approach of FIGS. 2A and 2B. In FIG. 3, an example of timesteps t0 and t1 is shown in greater detail. Timestep t1 is the first Trotter timestep from FIGS. 2A and 2B. Timestep to is an initial timestep, which was omitted from FIGS. 2A and 2B. The initial timestep to may not be a full Trotter timestep, as Trotter gates are not applied. Instead, the timestep t0 may be used to set up or initialize the simulation. In this example, the optimization referenced above with respect to FIG. 2B has two parts: first, the quantum circuit parameters θ are optimized using the classical ML optimizer 140 (e.g., HPC optimizer) and second the TN parameters χ and γ are updated using the classical GNN 130.

Specifically, an initial timestep to comprises a learning phase which begins with generation of an initial TN ansatz 180-0 according to any desired TN approach. In FIG. 3, an MPS based TN approach is illustrated for convenience, but any other TN approach such as a PEPS or TTN approach may be used to prepare the ansatz 180-0. The TN ansatz 180-0 comprises a decomposition of the quantum state into a tensor network and the partitioning of the quantum circuit into partitions P, based on parameters χ and γ, which characterize the bond dimension and TN layout, respectively. Default values for these parameters may be used in to. In the illustrated example, there are four QPUs 110, and therefore the partitions P used in the first time period to are the partitions P_{1,0}, P_{2,0}, P_{3,0}, and P_{4,0}, i.e., one for each QPU.

Then the quantum circuits U which represent the quantum state may be determined based on the TN ansatz 180 and based on default values for the parameters θ, which parametrize the circuits. Because there are four QPUs 110, there are four of these quantum circuits U which are applied, namely circuit U_{1,0} applied to QPU1, U_{2,0} applied to QPU2, U_{3,0} applied to QPU3, and U_{4,0} applied to QPU4. Each quantum circuit U is parameterized by its own individual parameter θ, i.e., U_{1,0} is parameterized by θ₁, U_{2,0} by θ₂, U_{3,0} by θ₃, and U_{4,0} by θ₄. Initially, default values for these parameters may be used. Note that each parameter θ₁, θ₂, . . . θₙ may itself include multiple specific parameter values, i.e., each parameter θ₁ may be a vector, matrix, array, or other multi-valued parameter.

Subsequently, measurements 184 of the qubits 181 may be performed and the resulting data may be fed to the classical ML optimizer 140. The classical optimizer 140 optimizes the parameters θ. The optimized θ values are then fed back to the QPUs 110 and are used to generate new quantum circuits U based thereon, which are more efficient at representing the overall quantum circuit. This process may be repeated until the parameters θ converge on optimal values (e.g., satisfy some threshold criterion).

In addition, once the optimized θ values are determined, the optimal values of parameters χ and γ may be determined by optimization performed by the GNN 130. The optimization may be such that it minimizes the engagement between subsystems (tensor network ansatz) during the time-evolution simulation. Once the optimized parameters χ and γ have been determined, a new TN ansatz 180-1 may be determined based on these parameters, and then new updated quantum circuits U to represent the quantum state can be determined for use in the next time step based on the new TN ansatz 180-1 and based on the updated parameters θ. Specifically, the circuit U_{1,0} is updated based on the new TN ansatz 180-1 and new values of 01 into the updated quantum circuit U_{1,1}, which is used by QPU1 in the next timestep t1. Similarly, the circuit U_{2,0} is updated based on the new TN ansatz 180-1 and new values of 02 into the updated quantum circuit U_{2,1}, which is used by QPU2 in the next timestep t1. And so on for each of the other circuits.

Timestep to may be unique, in some examples, in that it comprises only a learning phase and no forward simulation phase. This means that in timestep t0 no Trotter gates are applied. Timestep to may thus be considered as an initialization step, which places the QPUs into the initial quantum state of the quantum system being simulated, rather than as one of the regular Trotter timesteps.

The next timestep t1 comprises a forward simulation phase and a learning phase. The timestep t1 may be considered a Trotter timestep in that, in the forward simulation phase, a Trotter step is executed by applying the updated circuits U_{1,1} to U_{4,1} which were determined in the learning phase of the previous timestep t0 and applying the Trotter gates (not illustrated) which time-evolve the system by one time step Δt. The Trotter timestep t1 also comprises a learning phase, which follows the forward simulation phase. This learning phase may be similar to the learning phase of the t0 timestep except that instead of starting with default values for the various parameters, the updated values from the optimization performed in to are used as the starting values for this iteration of the learning phase. At the conclusion of the learning phase of the t1 timestep, new updated values for the parameters may be obtained, the TN ansatz 180 may be updated anew based on the updated TN parameters (forming TN ansatz 180-2), and new updated circuits (U_{1,2} to U_{4,2}) may be determined based on the updated circuit parameters. Each subsequent Trotter timestep may proceed in a similar fashion, starting with a forward simulation phase in which the updated circuits generated in the learning phase of the previous timestep are applied followed by a learning phase in which updated values of the parameters are determined and the TN ansatz and quantum circuits are updated based thereon. In this manner, the TN partitioning is dynamically updated from one timestep to the next by learning optimal parameters thereof during the simulation.

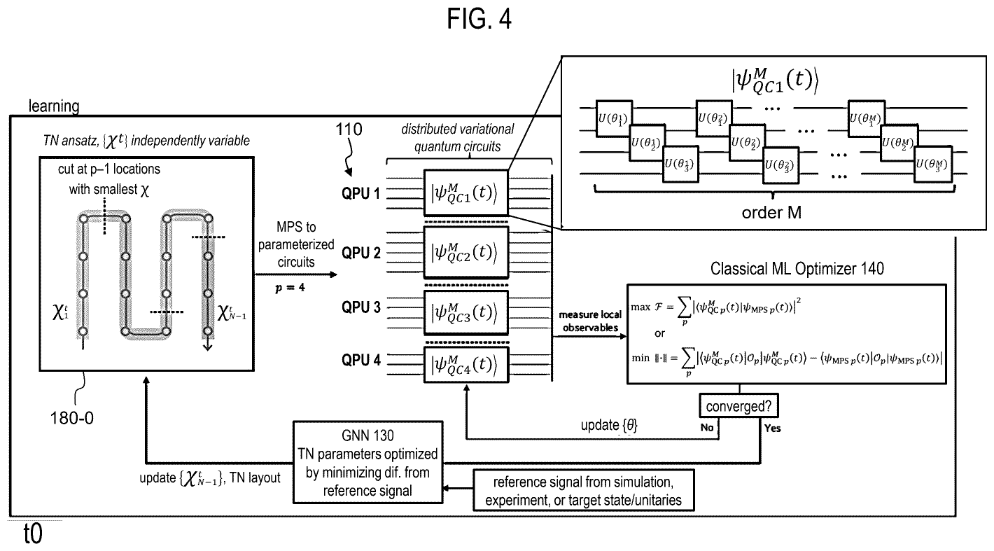

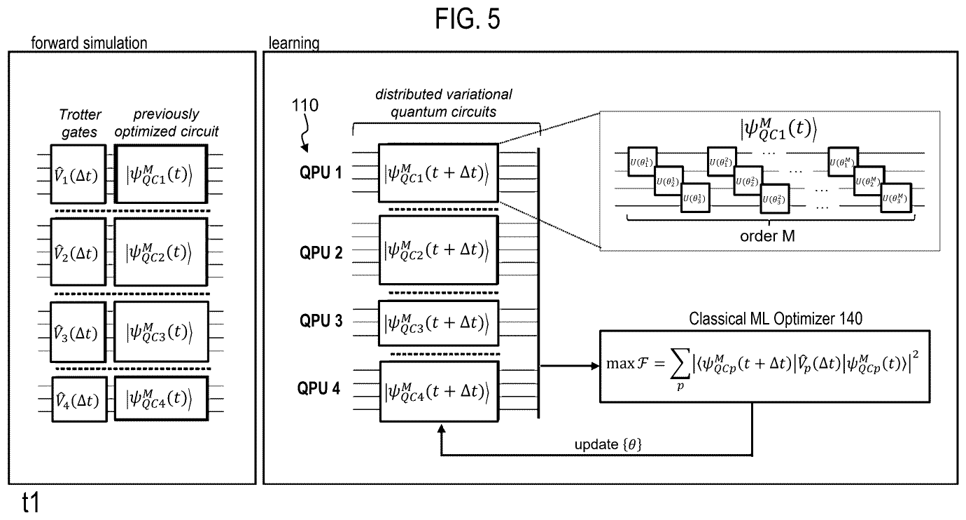

FIGS. 4 and 5 illustrate another example implementation of the example hybrid quantum-classical approach of FIGS. 2A and 2B. The example of FIGS. 4 and 5 is also one specific implementation of the example of FIG. 3, with FIG. 4 illustrating timestep t0 (which has a learning phase) in greater detail and FIG. 5 illustrating timestep t1 (which has a forward simulation phase and a learning phase) in greater detail. In this example, the quantum circuits U_{1,0} to U_{4,0} from FIG. 3 take the form of distributed variational quantum circuits, which are denoted |ψ_{QC1}^{M}(t) [symbol] , |ψ_{QC2}^{M}(t) [symbol] , |ψ_{QC3}^{M}(t) [symbol] , and |ψ_{QC4}^{M}(t) [symbol] , respectively. In this notation, M indicates the order of the distributed variational quantum circuit, and QCi denotes the i^{th} quantum circuit. Thus, |ψ_{QC1}^{M}(t) [symbol] at t=0 in FIG. 4 is one example implementation of U_{1,0} from FIG. 3, |ψ_{QC2}^{M}(t) [symbol] at t=0 in FIG. 4 is one example implementation U_{2,0} from FIG. 3, and so on.

Each distributed variational quantum circuit comprises multiple variational quantum logic gates U(θ₁¹), . . . , U(θ_{N}^{M}). Each of the variational quantum logic gates acts on two qubits of the QPU and is parameterized by a corresponding 0 (e.g., variational quantum logic gate U(θ₁¹) is parameterized by θ₁¹). In some examples, the variational quantum logic gates are arranged in M groups, with each group comprising N quantum logic gates. In some examples, each group acts collectively on all the qubits assigned to the corresponding distributed variational quantum circuit, with the groups arranged in series relative to one another. In FIG. 4, N=3 for QPU1, but in other examples N could be some other integer. In some examples, N=Q−1, where Q is the total number of qubits being acted on by the corresponding distributed variational quantum circuit in that timestep (thus, N may vary from one distributed variational quantum circuit to another and from one timestep to another).

As shown in FIG. 4, in this example the optimization of θ by the classical ML optimizer 140 may be performed based on one of two objective (cost) functions:

$$max ℱ = {\sum }_{p} {\vert 〈 {ψ}_{Q C p}^{M} ( t ) \vert {ψ}_{MPSp} ( t ) 〉 \vert}^{2} \\ or \\ min ‖ \cdot ‖ = {\sum }_{p} \vert 〈 {ψ}_{QCp}^{M} ( t ) \vert {𝒪}_{p} \vert {ψ}_{QCp}^{M} ( t ) 〉 - 〈 {ψ}_{MPSp} ( t ) \vert {𝒪}_{p} \vert {ψ}_{MPSp} ( t ) 〉 \vert$$

Here, |ψ_{MPSp}(t) [symbol] indicates a quantum state given by the portion of the MPS ansatz operating on QPU p at time t, and |ψ_{QCp}^{M}(t) [symbol] indicates the quantum circuit operating on QPU p at time t that is being variationally optimized. In the first cost function, the goal is to maximize the fidelity (overlap) of each variational quantum circuit with its respective MPS representation, finding a circuit of order M which most closely represents the MPS state. With a simulated QPU calculations of overlaps may be straightforward, but with a physical QPU it may be more desirable to measure local observables. The second cost function addresses this: the goal is to minimize the norm of a set of local observables computed from the variational circuit and from the MPS state. The objective is satisfied when the difference between the observables computed with the circuit and the observables computed with the MPS is minimized. Based on this optimization, new updated values for the parameters θ may be determined, and these may be fed back into the distributed variational quantum circuits. New measurements may be taken based on the new updated quantum circuits, and the optimization may be performed again, and new updated values for the parameters θ may be determined. This process may be repeated in a loop until the parameters θ converge. Once the parameters θ have converged, the optimization of the TN parameters may begin. Specifically, the GNN 130 may optimize the parameters χ and γ as discussed above. These updated parameters χ and γ are then used to create an updated partition (update TN ansatz) which is used in a subsequent timestep.

As shown in FIG. 5 the forward simulation phase of t1 comprises applying Trotter gates \hat{V}₁ to \hat{V}₄ to the quantum state represented by the previously optimized quantum circuits |ψ_{QC1}^{M}(t) [symbol] to |ψ_{QC4}^{M}(t) [symbol] , resulting in new time-evolved states |\hat{V}₁(Δt)|ψ_{QC1}^{M}(t) [symbol] to |\hat{V}₄(Δt)|ψ_{QCp}^{M}(t) [symbol] . Note that the quantum circuits |ψ_{QC1}^{M}(t) [symbol] to |ψ_{QC4}^{M}(t) [symbol] mentioned here were created based on the updated partition (TN ansatz) 180-1 and the updated parameters θ optimized in the previous timestep t0. The result of the application of the Trotter gates \hat{V}₁ to \hat{V}₄ is denoted |\hat{V}₁(Δt)|ψ_{QC1}^{M}(t) [symbol] to |\hat{V}₄(Δ)|ψ_{QCp}^{M}(t) [symbol] , which represent the time-evolution from the initial state |ψ_{QC1}^{M}(t) [symbol] to |ψ_{QC4}^{M}(t) [symbol] to the t1 state. Subsequently, in the learning phase of t1, new quantum circuits |ψ_{QC1}^{M}(t+Δt) [symbol] to |ψ_{QC4}^{M}(t+Δt) [symbol] which represent the t1 quantum state are generated based on the updated TN ansatz 180-1 (which was updated in the learning phase of t0) and these circuits are optimized, meaning that the parameters θ which parameterize these circuits are optimized using machine learning (via classical ML optimizer 140) in a similar fashion as was described previously with respect to t0. However, in the optimization of θ during t1, the states |\hat{V}₁(Δt)|ψ_{QC1}^{M}(t) [symbol] to |\hat{V}₄(Δt)|ψ_{QC4}^{M}(t) [symbol] which were obtained in the forward simulation phase of t1 are now used as the target states in the optimization instead of using the MPS state |ψ_{MPSp}(t) [symbol] as the target state as was done in t0. Specifically, the optimization may now be given by:

$$max ℱ = {\sum }_{p} {\vert 〈 {ψ}_{Q C p}^{M} ( t + Δ t ) \vert {\hat{V}}_{p} ( Δ t ) \vert {ψ}_{Q C p}^{M} ( t ) 〉 \vert}^{2}$$

where p is an index for the QPUs.

Although not shown in FIG. 5, it should be understood that in some examples the TN parameters (e.g., bond dimensions {χ^{t}} and a set of parameters {γ}) are also optimized by the GNN 130 in t1, in the same manner as described above in relation to t0. This results in a new updated TN ansatz 180-2, which is then subsequently acted upon in timestep t2. The process described above in relation to t1 may then be repeated for each subsequent timestep.

An example of pseudo code which may be used to implement the above-described example hybrid quantum-classical approach using dynamical circuit cutting is provided as follows:

Algorithm 1: TIME EVOLUTION
VIA DYNAMICAL CIRCUIT CUTTING

| learning | Input: H, \|ψ_{TN}(0) [symbol] , t_{end}, Δt, number of QPUs p | | |
|---|---|---|---|
| | Output: time-dependent observable | | |
| | for t = 0, t < t_{end}; t = t + Δt do | | |
| | \| | Optimize current timestep: Execute Alg. | |
| | \| | 2 for \|ψ_{TN}(t) [symbol] and obtain optimized states | |
| | \| | \|ψ_{QC,p}^{M}(t) [symbol] | |
| forward | \| | for each QPU p do | |
| simulation | \| | \| | Apply Trotter gates: Compute |
| | \| | \| | \hat{V}ₚ(Δt) \|ψ_{QC,p}^{M}(t) [symbol] |
| | \| | \| | Optimize partition: Find a new set of |
| | \| | \| | unitaries {U(θ_{t+Δt})} of order M that |
| | \| | \| | maximize |
| | \| | \| | [symbol] ψ_{QC,p}^{M}({U(θ_{t+Δt})}\|\hat{V}ₚ(Δt)\|ψ_{QC,p}^{M}(t) [symbol] |

| | |
|---|---|
| \| | end |
| \| | Compute observable |
| \| | Set guess for next timestep as current |
| \| | timestep |

end

learning
Algorithm 2: DYNAMICAL CIRCUIT CUTTING FEEDBACK STEP

| Input: \|ψ_{TN}({χ, γ}) [symbol] , number of QPUs p | | |
|---|---|---|
| Output: | | A set of bond dimensions and TN |
| | | layout {χ, γ) minimizing entanglement |
| | | and difference from reference signal |
| Graph NN setup: Encode \|ψ_{TN}({χ, γ}) [symbol] in | | |
| graph neural network. | | |
| while TN parameters not converged do | | |
| \| | Partition TN: Cut smallest bond | |
| \| | dimensions to create p partitions. | |
| \| | for each QPU p do | |
| \| | \| | Optimize partition: Find circuit |
| \| | \| | unitaries {U(θ)} of order M to |
| \| | \| | represent TN, i.e. maximize |
| \| | \| | [symbol] ψ_{QC,p}^{M}({U(θ)})\|ψ_{TN,p} [symbol] |

| | |
|---|---|
| \| | end |
| \| | Graph NN update: Update TN |
| \| | parameters {χ, γ} |

end

In the examples described above, the QPUs could be physical quantum processors or simulated quantum processors, but the optimization through machine learning is performed using classical computers. In other examples, the QPUs may all be physical quantum processors and at least some of the optimization described above may be performed using quantum machine learning executed by these QPUs. For example, in some implementations a quantum neural network (QNN) may be used to optimize the parameters θ during both learning and simulation phases. In some examples, classical computers may continue to be used to optimize the TN parameters.

In some examples, digital simulation of QPUs is used. In these examples, one can save states, reassign qubits, and adjust tree topology at will. Classical machine learning is used for learning the entanglement heatmap, and quantum machine learning is not required. The outcomes of local observables can be used to train the machine learning models. In one implementation, MPS is used for the TN partitioning. In this implementation, the optimization may find the best MPS representation using classical machine learning and forward simulate using this adaptive MPS. Open source MPS libraries are available, and there are known ways to translate MPS to quantum circuits. In another implementation TTN is used for the TN partitioning. In this implementation, the optimization may find the best TTN representation using classical machine learning and forward simulate with this adaptive TTN. TTNs may be better descriptions for 2D systems, but may have some limitations on code availability.

In some examples, QPUs are used, and classical machine learning and quantum machine learning are combined to learn new topologies. Quantum communication channels (e.g., LOCC/EPR pairs) may be required between QPUs to enable adaptively changing their topologies. In one implementation, an MPS ansatz is used as a starting point, and then quantum machine learning with circuit cutting is used to simulate therefrom. The QPU partitions are dynamically adapted. In another implementation a TTN ansatz is used instead of the MPS ansatz. At an initial time, a prior MPS ansatz is chosen which induces a partition of a problem into multiple QPUs by thresholding local bond dimensions. Then, QPUs parameters are learned variationally for each QPU in parallel without any quantum communications between them. Next a new MPS ansatz is iteratively learned via Local Operations and Classical Communications (LOCC) on each QPU and off-line classical ML. For a dynamical system when the entanglement is changing in time (e.g., time-dependent Hamiltonian or a non-equilibrium quantum quench) off-line share entanglement resources such as Einstein-Podolsky-Rosen pairs (EPR pairs) (also sometimes called Bell states) or Greenberger-Horne-Zeilinger states (GHZ states) between two or more quantum nodes/QPUs may be needed. Communication among QPUs can be done with state-of-the-art distributed classical memory, Message Passing Interface (MPI), and quantum teleportation updating the structure of each QPU dynamically. This is still possible via LOCC but one needs to have an entanglement sharing network in place. In other examples in which the protocol is simulated classically over multi GPUs, such shared entanglement or even access to QPUs is not required.

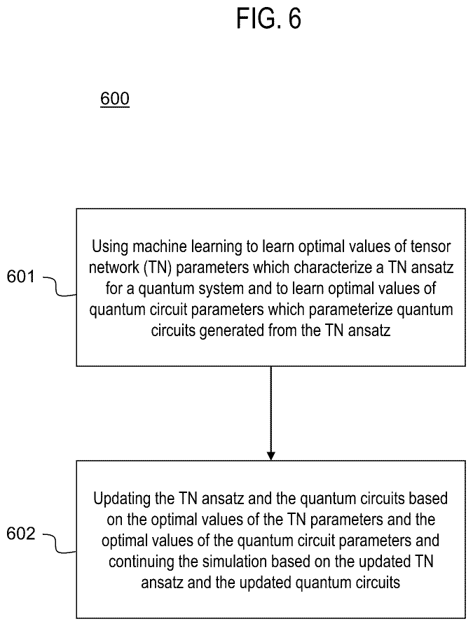

Turning to FIG. 6, an example method 600 will be described. The method 600 may be performed, for example, by, or with the use of, a hybrid quantum-classical computing system, such as system 100 described above. The method is performed as part of simulating a quantum system using a plurality of quantum processing units (QPUs), wherein a TN partitioning approach with Trotter time discretization is used.

In step 601, the method comprises (a) optimizing partitioning of a TN ansatz by learning optimal values of tensor network (TN) parameters which characterize the TN ansatz, and/or (b) optimizing the quantum circuits generated from the TN ansatz by learning optimal values of quantum circuit parameters which parameterize the quantum circuits. In some examples, the optimizations of (a) and/or (b) may be performed using machine learning. In some examples, this machine learning may include classical machine learning performed by classical computers, such as by GNN 130 or optimizer 140 described. In some examples, some or all of the machine learning may be quantum machine learning performed by quantum computers, such as using a quantum neural network (QNN). The parameters which are optimized may include the bond dimensions {χ^{t}}, the set of parameters {γ}, and the parameters θ described above. In some examples, the optimizing in (a) may correspond to the optimization performed by the GNN 130 as shown in FIG. 3 and described above. In some examples, the optimizing in (b) may correspond to the optimization performed by the Classical ML Optimizer 140 as shown in FIG. 3 or 4 and described above.

In step 601, the method comprises updating the TN ansatz and the quantum circuits based on the optimal values of the TN parameters and the optimal values of the quantum circuit parameters and continuing the simulation based on the updated TN ansatz and the updated quantum circuits. In some examples, the updating of the TN ansatz and the quantum circuits may correspond to updating the partitions P and circuits U as shown in FIGS. 2A and 2B and/or to the updating of {χ^{t}} and θ as shown in FIGS. 3-5.

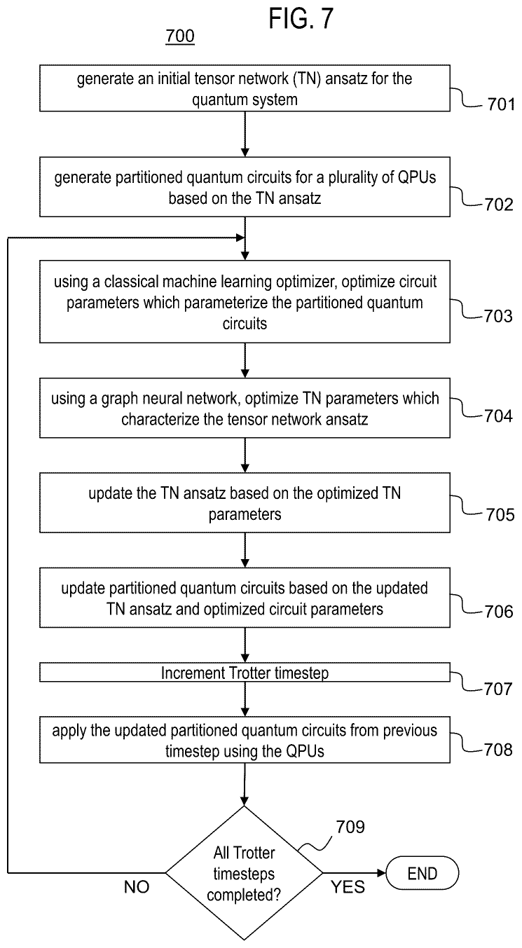

Turning to FIG. 7, an example method 700 will be described. The method 700 may be performed, for example, by, or with the use of, a hybrid quantum-classical computing system, such as system 100 described above. The method is performed as part of simulating a quantum system using a plurality of quantum processing units (QPUs), wherein a TN partitioning approach and Trotter time discretization approach are used. In some examples, steps 701-706 may be performed as part of an initial time period (e.g., timestep t0 shown in FIGS. 3 and 4), while step 707 may be performed as part of a first full Trotter timestep which follows the initial time period (e.g., timestep t1 shown in FIGS. 2A-3 and 5).

In step 701, the method comprises generating an initial tensor network (TN) ansatz for the quantum system. In some examples, this may correspond to the generation of the TN ansatz 180-0 as shown in FIGS. 3 and 4.

In step 702, the method comprises generating partitioned quantum circuits for a plurality of QPUs based on the TN ansatz. In some examples, this may correspond to the generation of the partitioned circuits U_{1,0} to U_{4,0} as shown in FIGS. 2B and 3 or the variational circuits denoted |ψ_{QC1}^{M}(t) [symbol] , |ψ_{QC2}^{M}(t) [symbol] , |ψ_{QC3}^{M}(t) [symbol] , and |ψ_{QC4}^{M}(t) [symbol] shown in FIG. 4.

In step 703, the method comprises using a classical machine learning optimizer, determining optimal values of circuit parameters which parameterize the partitioned quantum circuits. These parameters may include, for example, the parameters θ described above. This determining of the optimal values of the circuit parameters may also be referred to herein as optimizing the quantum circuits. In some examples, this optimization may correspond to the Classical ML Optimizer 140 learning optimal values for θ as shown in FIGS. 3-5.

In step 704, the method comprises using a graph neural network, determine optimal values of TN parameters which characterize the tensor network ansatz. These TN parameters may include, for example, the parameters {χ^{t}} and {γ} described above. This determining of the optimal values of the TN parameters may also be referred to herein as optimizing the partitioning of the quantum circuits. In some examples, this optimization may correspond to the GNN 130 learning optimal values for parameters {χ^{t}} as shown in FIGS. 3 and 4.

In step 705, the method comprises updating the TN ansatz based on the optimal values of the TN parameters. This results in a new TN ansatz which can be used in a subsequent time period. In some examples, this updating corresponds to the GNN 130 updating the parameters {χ^{t}} as shown in FIGS. 3 and 4, resulting in the new TN ansatz 180-1 shown in FIG. 3.

In step 706, the method comprises generating updated partitioned quantum circuits based on the updated TN ansatz and the optimal circuit parameters. These updated quantum circuits can be used in a subsequent time period. In some examples, this updating corresponds to the ML optimizer updating the parameters θ as shown in FIGS. 3 and 4, resulting in the new quantum circuits U which can be used in the forward simulation of the next time period. Specifically, when transitioning from the initial time step t0 to the first Trotter timestep t1, the quantum circuits are updated from circuits U_{1,0} to U_{4,0} to the new circuits U_{1,1} to U_{4,1} which are used in the forward simulation of timestep t1, as shown in FIG. 3.

In step 707, the trotter timestep is incremented. In a first iteration of the method, this may include incrementing from an initial time period (which may not count as a full trotter timestep) to a first trotter timestep. In subsequent iterations, the current trotter timestep is ended and the next trotter timestep begins.

In step 708, the method comprises applying the updated partitioned quantum circuits using the QPUs. This step may also include applying trotter gates to the updated quantum circuit, which time evolves the system to a next quantum state.

In decision block 709, it is determined whether all Trotter timesteps have been completed. If so (YES), the process ends. If not (NO), the process loops back to step 703.

In the description above, various types of electronic circuitry are described. As used herein, “electronic” is intended to be understood broadly to include all types of circuitry utilizing electricity, including digital and analog circuitry, direct current (DC) and alternating current (AC) circuitry, and circuitry for converting electricity into another form of energy and circuitry for using electricity to perform other regions. In other words, as used herein there is no distinction between “electronic” circuitry and “electrical” circuitry.

It is to be understood that both the general description and the detailed description provide examples that are explanatory in nature and are intended to provide an understanding of the present disclosure without limiting the scope of the present disclosure. Various mechanical, compositional, structural, electronic, and operational changes may be made without departing from the scope of this description and the claims. In some instances, well-known circuits, structures, and techniques have not been shown or described in detail in order not to obscure the examples. Like numbers in two or more figures represent the same or similar elements.

In addition, the singular forms “a”, “an”, and “the” are intended to include the plural forms as well, unless the context indicates otherwise. Moreover, the terms “comprises”, “comprising”, “includes”, and the like specify the presence of stated features, steps, operations, elements, and/or components but do not preclude the presence or addition of one or more other features, steps, operations, elements, components, and/or groups. Components described as connected may be electronically or mechanically directly connected, or they may be indirectly connected via one or more intermediate components, unless specifically noted otherwise. Mathematical and geometric terms are not necessarily intended to be used in accordance with their strict definitions unless the context of the description indicates otherwise, because a person having ordinary skill in the art would understand that, for example, a substantially similar element that regions in a substantially similar way could easily fall within the scope of a descriptive term even though the term also has a strict definition.

And/or: Occasionally the phrase “and/or” is used herein in conjunction with a list of items. This phrase means that any combination of items in the list—from a single item to all of the items and any permutation in between—may be included. Thus, for example, “A, B, and/or C” means “one of {A}, {B}, {C}, {A, B}, {A, C}, {C, B}, and {A, C, B}”.

Elements and their associated aspects that are described in detail with reference to one example may, whenever practical, be included in other examples in which they are not specifically shown or described. For example, if an element is described in detail with reference to one example and is not described with reference to a second example, the element may nevertheless be claimed as included in the second example.

Unless otherwise noted herein or implied by the context, when terms of approximation such as “substantially,” “approximately,” “about,” “around,” “roughly,” and the like, are used, this should be understood as meaning that mathematical exactitude is not required and that instead a range of variation is being referred to that includes but is not strictly limited to the stated value, property, or relationship. In particular, in addition to any ranges explicitly stated herein (if any), the range of variation implied by the usage of such a term of approximation includes at least any inconsequential variations and also those variations that are typical in the relevant art for the type of item in question due to manufacturing or other tolerances. In any case, the range of variation may include at least values that are within ±1% of the stated value, property, or relationship unless indicated otherwise.

Further modifications and alternative examples will be apparent to those of ordinary skill in the art in view of the disclosure herein. For example, the devices and methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various examples shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the scope of the present teachings and following claims.

It is to be understood that the particular examples set forth herein are non-limiting, and modifications to structure, dimensions, materials, and methodologies may be made without departing from the scope of the present teachings.

Other examples in accordance with the present disclosure will be apparent to those skilled in the art from consideration of the specification and practice of the invention disclosed herein. It is intended that the specification and examples be considered as exemplary only, with the following claims being entitled to their fullest breadth, including equivalents, under the applicable law.

What is claimed is:

1. A hybrid quantum-classical computing system, comprising:
a plurality of quantum processing units (QPUs);
at least one classical processor; and
a non-transitory storage medium comprising instructions executable by the classical processor to cause the computing system to:
generate a tensor network (TN) ansatz for a quantum system to be simulated by the QPUs;
generate partitioned quantum circuits for the QPUs based on the TN ansatz; and
optimize circuit parameters which parameterize the partitioned quantum circuits.

2. The computing system of claim 1,
wherein the instructions cause the computing system to optimize partitioning of the quantum circuits by optimizing TN parameters which characterize the TN ansatz.

3. The computing system of claim 2,
wherein the instructions cause the computing system to simulate the quantum system in Trotter timesteps and to, iteratively across successive Trotter timesteps, optimize the TN parameters and update the partitioning of the quantum circuits based on the optimized TN parameters.

4. The computing system of claim 2,
wherein the instructions cause the computing system to use machine learning to optimize the circuit parameters and to use machine learning to optimize the TN parameters.

5. The computing system of claim 4,
wherein using the machine learning comprises using classical machine learning to optimize one or both of the circuit parameters and the TN parameters.

6. The computing system of claim 4,
wherein using the machine learning comprises using quantum machine learning to optimize one or both of the circuit parameters and the TN parameters.

7. The computing system of claim 2, further comprising:
a classical machine learning optimizer; and
a graph neural network,
wherein the instructions cause the computing system use the classical machine learning optimizer to optimize the circuit parameters, and
wherein the instructions cause the computing system to use the graph neural network to optimize the TN parameters.

8. The computing system of claim 2,
wherein instructions cause the computing system to optimize partitioning of the quantum circuits by optimizing TN parameters by finding boundaries of minimal entanglement in the quantum system.

9. The computing system of claim 1,
wherein the partitioned quantum circuits comprise distributed variational quantum circuits.

10. A hybrid quantum-classical method of simulating a quantum system using a plurality of quantum processing units (QPUs), comprising:
generating a tensor network (TN) for the quantum system; and
optimizing quantum circuit parameters which parameterize quantum circuits generated from the TN ansatz.

11. The method of claim 10, further comprising:
optimizing the partitioning of the quantum circuits by optimizing TN parameters which characterize the TN ansatz; and
updating the TN ansatz and the quantum circuits based on the TN parameters and quantum circuit parameters as optimized and continuing the simulation based on the TN ansatz and the quantum circuits as updated.

12. The method of claim 11, further comprising:
simulating the quantum system in Trotter timesteps; and
optimizing the TN parameters and updating the partitioning of the quantum circuits based on the optimized TN parameters iteratively across successive Trotter timesteps.

13. The method of claim 11, further comprising:
wherein optimizing the circuit parameters comprises using machine learning to optimize the circuit parameters, and optimizing the TN parameters comprises using machine to optimize the TN parameters.

14. The method of claim 13,
wherein using the machine learning comprises using classical machine learning to optimize one or both of the circuit parameters and the TN parameters.

15. The method of claim 13,
wherein using the machine learning comprises using a classical machine learning optimizer to optimize the circuit parameters, and using a graph neural network to optimize the TN parameters.

16. The method of claim 13,
wherein using the machine learning comprises using quantum machine learning to optimize one or both of the circuit parameters and the TN parameters.

17. The method of claim 10,
wherein the partitioned quantum circuits comprise distributed variational quantum circuits.

18. A non-transitory computer readable medium storing instructions executable by a classical processor of a hybrid quantum-classical computing system, the instructions configured to, when executed, cause the computing system to:
in an initial time period:
generate a TN ansatz for a quantum system to be simulated by quantum processing units (QPUs) of the computing system and generate partitioned quantum circuits based on the TN ansatz; and
use machine learning to optimize circuit parameters which parameterize the partitioned quantum circuits.

19. The computer readable medium of claim 18, wherein the instructions are configured to, when executed, cause the computing system to:
use machine learning to optimize the partitioning of the quantum circuits by optimizing TN parameters which characterize the TN ansatz; and
update the TN ansatz based on the TN parameters as optimized, and update the partitioned quantum circuits based on the TN ansatz as updated and the circuit parameters as optimized.

20. The computer readable medium of claim 19, wherein the instructions are configured to, when executed, cause the computing system to:
after the initial time period, simulate the quantum system in Trotter timesteps and to, iteratively across successive Trotter timesteps, optimize the TN parameters and update the partitioning of the quantum circuits based on the optimized TN parameters.
